(19) United States
(12) Patent Application Publication
(10) Pub. No.: US 2019/0380896 A1
(43) Pub. Date: Dec. 19, 2019

(54) CHAIR SAFETY SYSTEM AGAINST ACCIDENTAL PRESSING

(71) Applicant: Andy Wang, Taichung City (TW)

(72) Inventor: Andy Wang, Taichung City (TW)

(21) Appl. No.: 16/009,582

(22) Filed: Jun. 15, 2018

(51) Int. Cl. A61G 5/14; G05B 9/02; A47C 1/024; A47C 31/00

(52) U.S. Cl. CPC A61G 5/14; G05B 9/02; A61G 2203/726; A47C 31/008; A47C 1/0244

(57) ABSTRACT

A chair safety system against accidental pressing has a central processing unit, multiple sensors, multiple linear pushrods, a power device, and a controller. The multiple sensors, the multiple linear pushrods, the power device, and the controller are electrically connected to the central processing unit, respectively. The multiple sensors include a first sensor and at least one second sensor that are respectively mounted to the linear pushrods, a linkage of a height adjustable chair, or a seat of the height adjustable chair. The first sensor is a human touch sensor or a Hall Effect sensor. The at least one second sensor is a pyroelectric sensor, a microwave sensor, or an ultrasonic sensor. By different sorts of the sensors working simultaneously, the linear pushrods will be stopped if any obstacles exist below the seat; thus damage to the obstacles and the seat may be prevented.

### BACKGROUND OF THE INVENTION

### 1. Field of the Invention

The present invention relates to a safety system for a chair, and more particularly to a chair safety system that may detect an area below a descending seat of a chair to prevent accidental pressing on obstacles in the area of the chair.

### 2. Description of Related Art

Aging population all over the world has raised demands for elder-friendly apparatus, for example, height adjustable chairs. It is difficult for seniors with powerless legs to squat down gradually to sit on a chair, and a height adjustable chair is for solving this problem.

A conventional height adjustable chair has a seat, a backrest, a leg rest, and a linkage connected to the seat, the backrest, and the leg rest. With a remote control, a user may drive the linkage to function so as to adjust either a height of the seat, a tilt of the backrest, or a height of the leg rest. Thus, the user may raise the seat to approach his hips, and then the user may easily sit on the seat. After seated on the conventional height adjustable chair, the user may once again adjust the seat, the backrest, and the leg rest to a comfortable position.

However, the conventional height adjustable chair has the following shortcomings.

1. Below the seat, there is a blind area. If children or pets run into the blind area during a descending process of the seat, the children or the pets will probably be squeezed or pressed by the seat or the linkage.

2. Obstacles under the descending seat may also be broken, or cause damage to the conventional height adjustable chair.

### SUMMARY OF THE INVENTION

The main objective of the present invention is to provide a chair safety system. With multiple sensors, accidental pressing on obstacles under a descending seat of a chair is preventable.

The chair safety system is applied to control a height adjustable chair that comprises a seat, a backrest, and a leg rest.

The chair safety system has a central processing unit, multiple sensors, multiple linear pushrods, a power device, and a controller. The multiple sensors are electrically connected to the central processing unit, and comprise a first sensor and at least one second sensor. The first sensor is electrically connected to the central processing unit, and is used to detect if any obstacles exist below the seat. The at least one second sensor is a different sort of sensor from the first sensor, is electrically connected to the central processing unit, and is used to detect if any obstacles exist below the seat. The multiple linear pushrods are connected to the seat, the backrest, and the leg rest, and drive the seat, the backrest, and the leg rest to move respectively. The power device is electrically connected to the central processing unit. The controller is electrically connected to the central processing unit. When the first sensor detects an obstacle, the first sensor will send a first actuation signal to the central processing unit to stop movements of the multiple linear pushrods; when the at least one second sensor detects an obstacle, the at least one second sensor will send a second actuation signal to the central processing unit to stop movements of the multiple linear pushrods.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a chair safety system against accidental pressing in accordance with the present invention;

FIG. 2 is a side view of a chair applied with the chair safety system in FIG. 1; and

FIGS. 3 and 4 are operational side views of the chair in FIG. 2.

### DETAILED DESCRIPTION OF THE PREFERRED EMBODIMENT

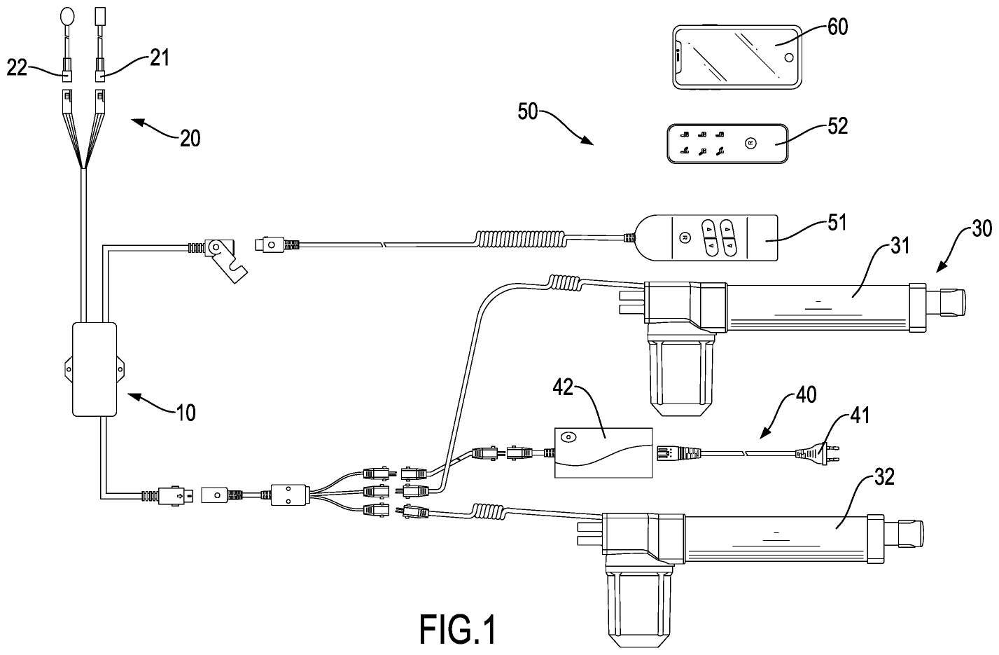

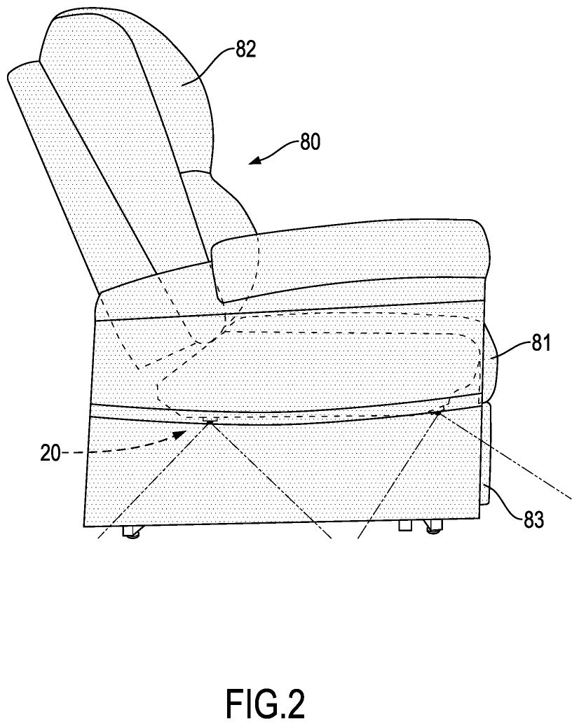

With reference to FIGS. 1 and 2, a first embodiment of a chair safety system against accidental pressing is applied with a height adjustable chair 80. The height adjustable chair 80 comprises a seat 81, a backrest 82, a leg rest 83, and a linkage 84 at a bottom of the height adjustable chair 80. The linkage 84 is made of an electrically conductive material, and is connected to the seat 81, the backrest 82, and the leg rest 83. The height adjustable chair 80 is conventional, and the features and the structures of the height adjustable chair 80 are not described in detail.

The chair safety system against accidental pressing in accordance with the present invention comprises a central processing unit 10, multiple sensors 20, multiple linear pushrods 30, a power device 40, and a controller 50. The sensors 20, the linear pushrods 30, the power device 40, and the controller 50 are electrically connected to the central processing unit 10.

In the first embodiment of the present invention, the central processing unit 10 is a microcomputer used to receive signals from the multiple sensors 20 and the controller 50, and to drive the multiple linear pushrods 30.

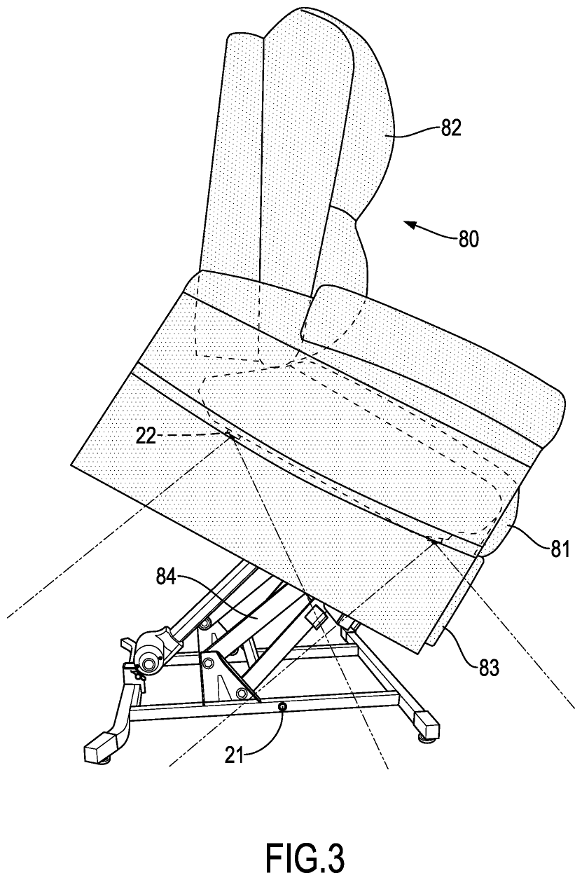

With reference to FIG. 1, the multiple sensors 20 comprise a first sensor 21 and at least one second sensor 22. With reference to FIG. 3, a first sensor 21 and two second sensors 22 are used for detailed description in the first embodiment in accordance with the present invention. The first sensor 21 is a human touch sensor. Each one of the two second sensors 22 is a pyroelectric sensor or a microwave sensor.

The first sensor 21 is mounted on the linkage 84 and is located below the seat 81. The first sensor 21 applies a voltage on the linkage 84, so an electric field will be generated on the linkage 84. Also, the first sensor 21 measures a value of capacitance of the linkage 84. Once a person or a creature touches the linkage 84, capacitance will be changed, and then the first sensor 21 will send a signal to the central processing unit 10. In the first embodiment of the present invention, the linkage 84 is made of metal, and is coated with electrically conductive paint. The two second sensors 22 are mounted on a bottom side of the seat 81 at a spaced interval, and are used to detect if any obstacles are located below the seat 81.

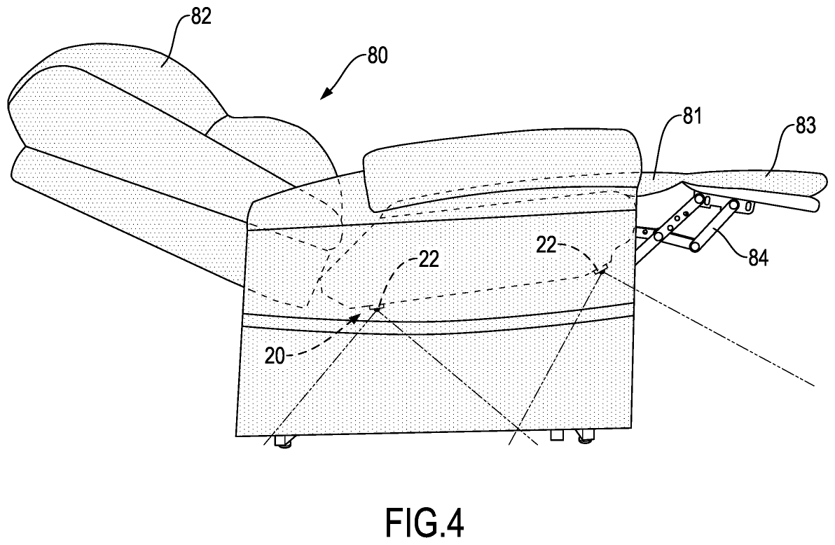

With reference to FIGS. 3 and 4, the multiple linear pushrods 30 are connected to the linkage 84. Powered by electricity, each one of the multiple linear pushrods 30 may extend out and retract back in order to adjust the seat 81, the backrest 82, and the leg rest 83. In the first embodiment of the present invention, the multiple linear pushrods 30 comprise a first linear pushrod 31 and a second linear pushrod 32, for different functions. For instance, the first linear pushrod 31 may be used to control the linkage 84 to incline the backrest 82 for a comfortable lying position or a sit-up position depending on a user, while the second linear pushrod 32 may be used to control the ascending and descending of the seat 81 and the leg rest 83, for an appropriate height for the user.

To supply electric power, the power device 40 comprises a plug 41 and a transformer 42. The plug 41 is connected to a socket for electricity supply. The transformer 42 is connected to the plug 41. To supply electrical power for other components of the chair safety system, the transformer 42 converts the electricity from the plug 41 into direct current (DC) power.

The controller 50 is a remote control having buttons for ascending and descending of the seat 81 and the leg rest 83, inclining of the backrest 82, and cancelling of a locked mode. The controller 50 may be a wired remote control 51 or a wireless remote control 52, wherein the wired remote control 51 is wired to the central processing unit 10, and the wireless remote control 52 is connected with the central processing unit 10 wirelessly.

Besides, the central processing unit 10 may have a wireless transmission circuit such as a Bluetooth circuit. Then a communication device 60 may control the chair safety system via wireless signals to the central processing unit 10. The communication device 60 is able to cancel the locked mode as well, and the communication device 60 may be a mobile phone.

With reference to FIGS. 2 to 4, the user may send commands to the central processing unit 10 with the controller 50 or the communication device 60 so as to adjust the height adjustable chair 80. During the adjusting process, if a child or a pet accidentally touches the linkage 84, the first sensor 21 will measure a variance of the capacitance and send a first actuation signal to the central processing unit 10. Then the central processing unit 10 will turn into the locked mode to stop the motions of the multiple linear pushrods 30 instantly from pressing the height adjustable chair 80 on the child or the pet.

Moreover, as a pyroelectric sensor or a microwave sensor, each one of the two second sensors 22 is able to detect presence of creatures. When the second sensor 22 detects the child or the pet entering an area below the seat 81 of the height adjustable chair 80, a second actuation signal will be sent to the central processing unit 10, and the central processing unit 10 will turn into the locked mode. In addition, the second sensor 22 may be applied with a modulating unit, which is used to adjust a range of detection of the second sensor 22. The amount of the second sensor 22 may be more than two to make the height adjustable chair 80 safer.

Once the central processing unit 10 has turned into the locked mode due to a child, a pet or any other kinds of obstacles entering the area below the seat 81, the multiple linear pushrods 30 are stopped from further extending or retracting. To drive the multiple linear pushrods 30 to work anew, the user has to remove the child, the pet, or the other obstacles away from the height adjustable seat 80, and press the corresponding button of the controller 50 or the communication device 60 for cancelling the locked mode. As the locked mode is cancelled, the multiple linear pushrods 30 may continue to lower down the seat 81.

A second embodiment of a chair safety system in accordance with the present invention differs from the first embodiment in that the second sensor 22 is an ultrasonic sensor. The ultrasonic sensor continuously emits ultrasonic waves toward the area below the seat 81, receives reflected waves, and records time taken by the ultrasonic waves to travel from emission to receipt. Therefore, if an obstacle appears in the area below the seat 81, changes in the time taken by the ultrasonic waves will be detected, and then the two second sensors 22 will send a second actuation signal to the central processing unit 10 to stop the multiple linear pushrods 30.

A third embodiment of a chair safety system in accordance with the present invention differs from the first embodiment in that the first sensor 21 is a Hall Effect sensor. The first sensor 21 is mounted on one of the multiple linear pushrods 30, and is electrically connected to the central processing unit 10 and the power device 40. The first sensor 21 is used to detect values of currents in ascending and descending processes of the seat 81. In order to completely lower down the seat 81, a larger current is required by the multiple linear pushrods 30 when the seat 81 descends and presses on an obstacle. If the current goes beyond a threshold value, the first sensor 21 will send a first actuation signal to the central processing unit 10 to stop the multiple linear pushrods 30.

In a fourth embodiment of a chair safety system in accordance with the present invention, the first sensor 21 is a Hall Effect sensor, and the first sensor 21 works as described in the third embodiment; the second sensor 22 is an ultrasonic sensor, and the second sensor 22 works as described in the second embodiment.

With the aforementioned technical features, the chair safety system against accidental pressing in accordance with the present invention has the following advantages.

1. Two different kinds of sensors, the first sensor 21 and the second sensor 22, are applied simultaneously. Even if one of the first sensor 21 and the second sensor 22 malfunctions, accidental pressing may still be avoided by the remaining one of the sensors 21, 22.

2. The locked mode should be cancelled manually by the user, so the seat 81 will not descend anew unless the user confirms that the child, the pet, or the other obstacles below the seat 81 have been removed.

3. It is convenient for the user that the chair safety system may also be manually operated by the communication device 60 such as a mobile phone.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A chair safety system against accidental pressing, the chair safety system applied to control a height adjustable chair that comprises a seat, a backrest, and a leg rest, and the chair safety system comprising:
a central processing unit;
multiple sensors electrically connected to the central processing unit, and comprising
a first sensor electrically connected to the central processing unit to detect if any obstacles exist below the seat; and
at least one second sensor being a different sort of sensor from the first sensor, and electrically connected to the central processing unit to detect if any obstacles exist below the seat;
multiple linear pushrods connected to the seat, the backrest, and the leg rest, and driving the seat, the backrest, and the leg rest to move, respectively;
a power device electrically connected to the central processing unit; and
a controller electrically connected to the central processing unit; wherein
when the first sensor detects an obstacle, the first sensor will send a first actuation signal to the central processing unit to stop movements of the multiple linear pushrods; and
when the at least one second sensor detects an obstacle, the at least one second sensor will send a second actuation signal to the central processing unit to stop movements of the multiple linear pushrods.

2. The chair safety system as claimed in claim 1, wherein the multiple linear pushrods include
a first linear pushrod used to incline the backrest of the height adjustable chair; and
a second linear pushrod used to raise or lower the seat.

3. The chair safety system as claimed in claim 2, wherein the first sensor is a human touch sensor mounted on a linkage of the height adjustable chair.

4. The chair safety system as claimed in claim 2, wherein the first sensor is a Hall Effect sensor mounted on one of the multiple linear pushrods, and is electrically connected to the central processing unit and the power device.

5. The chair safety system as claimed in claim 3, wherein the at least one second sensor is a pyroelectric sensor or a microwave sensor, and is mounted on a bottom side of the seat.

6. The chair safety system as claimed in claim 4, wherein the at least one second sensor is a pyroelectric sensor or a microwave sensor, and is mounted on a bottom side of the seat.

7. The chair safety system as claimed in claim 3, wherein the at least one second sensor is an ultrasonic sensor mounted on a bottom side of the seat.

8. The chair safety system as claimed in claim 4, wherein the at least one second sensor is an ultrasonic sensor mounted on a bottom side of the seat.

9. The chair safety system as claimed in claim 5, wherein the controller is a wired remote control that is wired to the central processing unit, and the controller has a button for cancelling a locked mode that is to stop movements of the multiple linear pushrods.

10. The chair safety system as claimed in claim 6, wherein the controller is a wired remote control that is wired to the central processing unit, and the controller has a button for cancelling a locked mode that is to stop movements of the multiple linear pushrods.

11. The chair safety system as claimed in claim 7, wherein the controller is a wired remote control that is wired to the central processing unit, and the controller has a button for cancelling a locked mode that is to stop movements of the multiple linear pushrods.

12. The chair safety system as claimed in claim 8, wherein the controller is a wired remote control that is wired to the central processing unit, and the controller has a button for cancelling a locked mode that is to stop movements of the multiple linear pushrods.

13. The chair safety system as claimed in claim 5, wherein the controller is a wireless remote control that is connected with the central processing unit via wireless signals, and the controller has a button for cancelling a locked mode that is to stop movements of the multiple linear pushrods.

14. The chair safety system as claimed in claim 6, wherein the controller is a wireless remote control that is connected with the central processing unit via wireless signals, and the controller has a button for cancelling a locked mode that is to stop movements of the multiple linear pushrods.

15. The chair safety system as claimed in claim 7, wherein the controller is a wireless remote control that is connected with the central processing unit via wireless signals, and the controller has a button for cancelling a locked mode that is to stop movements of the multiple linear pushrods.

16. The chair safety system as claimed in claim 8, wherein the controller is a wireless remote control that is connected with the central processing unit via wireless signals, and the controller has a button for cancelling a locked mode that is to stop movements of the multiple linear pushrods.
